(19) United States
(12) Patent Application Publication
(10) Pub. No.: US 2014/0192964 A1
(43) Pub. Date: Jul. 10, 2014

(54) INTELLIGENT 911 SERVICE

(71) Applicant: INTERNATIONAL BUSINESS MACHINES CORPORATION, Armonk, NY (US)

(72) Inventors: Kulvir S. Bhogal, Fort Worth, TX (US); Gregory J. Boss, Saginaw, MI (US); Rick A. Hamilton, II, Charlottesville, VA (US); Anne R. Sand, Canon City, CO (US)

(73) Assignee: INTERNATIONAL BUSINESS MACHINES CORPORATION, Armonk, NY (US)

(21) Appl. No.: 13/734,440

(22) Filed: Jan. 4, 2013

(51) Int. Cl. H04M 3/51

(52) U.S. Cl. CPC H04M 3/5116
USPC 379/45

(57) ABSTRACT

A computer system manages emergency calls. The computer system receives an emergency call from a computing device along with a location of the computing device. The computer system determines that the location of the computing device is within a geographic area surrounding a location of a previously reported incident and sends a notification of the previously reported incident to the computer device. The computer system receives an indication from the computing device that the emergency call is related to the previously reported incident. Responsive to receiving the indication that the emergency call is related to the previously reported incident, the computer system handles the emergency call as a duplicative report of a known emergency.

### FIELD OF THE INVENTION

The present invention relates generally to the field of communications systems, and more particularly to managing calls made to an emergency communication system.

### BACKGROUND OF THE INVENTION

The 9-1-1 system, typically based on the standard public switched telephone network (PSTN), constantly adapts to evolving technology, including the proliferation of cell phones and VoIP. The PSTN system routes 9-1-1 calls to a call center created to take calls made to an emergency telephone number, nearest to where the call originated. Such a call center may be referred to as a Public Safety Answering Point (PSAP).

In typical operation, for billing purposes, a phone company knows every time a call is placed from a given phone number. This system of identifying calling numbers is referred to as an Automatic Number Identification (ANI) system. For 9-1-1 purposes this functionality is adapted such that when a 9-1-1 call is placed, the phone company recognizes that an emergency number has been dialed, and uses the ANI system to pull up the calling phone number. The phone company then routes the call to a dedicated 9-1-1 switch that acts as a hub for a local network. The network uses the retrieved number to determine the caller's address. The phone company has a subscriber database that matches phone numbers to names and addresses. This is referred to as Automatic Location Identification (ALI) data. When an emergency call arrives at the 9-1-1 network, the hub taps into this database to pull up the address that matches the phone number. The 9-1-1 system uses the address to determine the proper PSAP destination. For example, the phone company and public safety agencies may collaborate to create master maps that match phone numbers, addresses, and cross streets to their corresponding PSAP (this is sometimes referred to as a Master Street Address Guide, or MSAG). The phone call now carries the calling phone number, a corresponding address, and any voice data to the nearest available PSAP. A PSAP call-taker (also referred to an operator or dispatcher) receives the call, and location information is displayed on the PSAP call-taker's computer. Some PSAPs simultaneously send the ANI/ALI data to a police computer dispatch network to allow for immediate access. If necessary, a typical PSAP can transfer a call and accompanying data to another PSAP.

By the very nature of a mobile phone, no set corresponding location exists. In such a scenario, the network can identify a location of the mobile phone for determining which PSAP to route the call to and/or to provide a location for the call-taker. For example, the network may use the location of the cell-tower antenna the mobile phone is using, and route the call to the PSAP nearest the tower. In another example, trilateration may be used to determine a more precise location of the mobile phone.

In one implementation of the trilateration method, when someone dials 9-1-1 on a mobile phone, a GPS receiver of the mobile phone locates itself using satellites. The GPS receiver taps into radio signals emitted by at least three satellites and times how long it takes the signals to reach the receiver. Using trilateration, the receiver can then determine its location. In another implementation, additional radio equipment may be added to network base stations. The mobile phone sends out radio signals to at least three of these towers, and a receiver in each tower times how long it takes for each signal to reach its receiver. Using trilateration, the network can then pinpoint the location of the mobile phone.

Once the location is determined, latitude and longitude coordinates can be sent in addition to voice data and a phone number. The mobile switch either forwards the call to the dedicated 9-1-1 switch (the same ones used by landline calls) for PSAP routing or routes the call itself to the nearest PSAP, depending on the routing path the wireless carrier chooses. At the PSAP, mapping equipment may convert those coordinates to a street address.

VoIP (voice over internet protocol) also poses some unique challenges as the number does not necessarily have a physical location (many VoIP systems are completely portable and can work from any broadband connection). Typically, a default physical location is required by the provider when an account is established, and it is this location that is used for routing 9-1-1 calls.

### SUMMARY

Embodiments of the present invention disclose a method, computer program product, and computer system for managing emergency calls. The method comprises receiving an emergency call from a computing device; receiving a location of the computing device placing the emergency call; determining, by one or more computer processors, that the location of the computing device is within a geographic area surrounding a location of a previously reported incident; sending a notification of the previously reported incident to the first computer device; receiving an indication from the first computing device that the emergency call is related to the previously reported incident; and responsive to receiving the indication that the emergency call is related to the previously reported incident, handling the emergency call as a duplicative report of a known emergency.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a flowchart depicting operational steps of an incident report creation program for creating and storing incident reports, in accordance with an embodiment of the present invention.

FIGS. 3, 4, and 5 depict the operational steps of an emergency calling program on a client computer system for sending out an emergency call and interacting with a server computer system of the 9-1-1 system, and the operational steps of an incident report comparison program on the server computer system for receiving an emergency call and interacting with the calling client computer system, in accordance with one embodiment of the present invention.

FIG. 6 is a block diagram of components of a computing system, such as the client computer system and the server computer system, in accordance with an illustrative embodiment of the present invention.

### DETAILED DESCRIPTION

Embodiments of the present invention recognize that at certain times, when there is a public emergency for example, 9-1-1 operators may be overwhelmed by emergency calls. Many of the calls may be duplicative, and these duplicative calls may prevent new emergencies from being reported. Embodiments of the present invention enable the 9-1-1 system to recognize and manage such duplication, thereby making the 9-1-1 system more efficient and better able to assist those in need.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable media having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

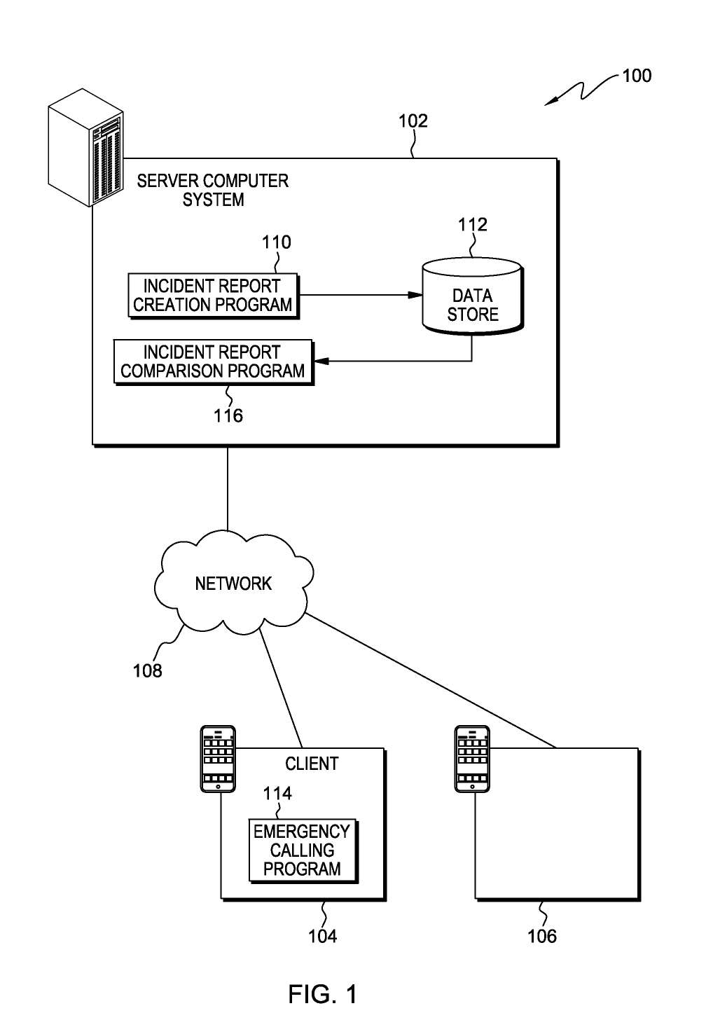

The present invention will now be described in detail with reference to the Figures. FIG. 1 is a functional block diagram illustrating a distributed data processing environment, generally designated 100, in accordance with one embodiment of the present invention.

Distributed data processing environment 100 includes server computer system 102, client computer system 104, and client computer system 106 interconnected over network 108.

Server computer system 102 may be a laptop computer, tablet computer, netbook computer, personal computer (PC), a desktop computer, or any programmable electronic device capable of receiving an emergency phone call from a telephonic device such as client computer system 104 or client computer system 106, via network 108. Server computer system 102 is also capable of responding to client computer system 104, identifying sent data attached to or corresponding to the emergency phone call from the client computer system 104, and forwarding the phone call on to a PSAP or an operator. In one embodiment, server computer system 102 is an intermediate computer or switch and determines where and if an emergency phone call should be forwarded to a PSAP. In another embodiment, a local PSAP maintains server computer system 102 such that server computer system 102 is accessible to operators at the local PSAP, and server computer system 102 determines whether to forward an emergency phone call to an operator of the local PSAP.

Client computer system 104 may be any programmable electronic device capable of placing a phone call and of communicating with server computer system 102 via network 108. In a preferred embodiment, client computer system 104 is a smartphone. In another embodiment, client computer system 104 may be a computer connected to a VoIP system.

In general, network 108 can be any combination of connections and protocols that will support communications between client computer system 104 and server computing system 102. Network 108 can include, for example, a local area network (LAN), a wide area network (WAN) such as the internet, a cellular network, or any combination of the preceding, and can further include one or more carrier switches, one or more 911 switches, and wired, wireless, and/or fiber optic connections.

In one embodiment, incident report creation program 110, resides on server computer system 102 and may create and store incident reports as new emergency calls are received (e.g., in data store 112). Incident reports may be forwarded to a police dispatcher and may be searched by server computer system 102.

Emergency calling program 114 resides on client computer system 104. Emergency calling program 114 can detect when a user of client computer system 104 attempts to make an emergency call, gathers relevant caller information (e.g., caller identity, location information), and transmits the call with the caller information. Emergency calling program 114 is also capable of receiving digital information back from a system that received the call (e.g., server computer system 102), and displaying that information to the user. For example, in one embodiment, emergency calling program 114 may receive back from server computer system 102 a list of previously reported incidents near the location of client computer system 104 (e.g., an incident reported by a user of client computer 106). Emergency calling program 114 may display these incidents to the user and allow the user to select one of the incidents if the user placed the call with regard to one of them. If the user selects an incident, he or she may submit additional information regarding the incident. If the user indicates that his or her call is not related to any of the incidents, emergency calling program 114 relays this information back to the server computer system 102, where the call may be routed to a live operator. Thus, operators are not inundated with multiple calls concerning the same incident. This may help keep emergency lines open for unreported emergencies, especially in the case of large public incidents.

Incident report comparison program 116 resides on server computer system 102 and compares received emergency calls to existing incident reports. More specifically, incident report comparison program 116 may receive the caller's location and identify incidents that occurred with a specified spatial proximity of the caller's location. If incidents are found, instead of forwarding the call to an appropriate PSAP or to an operator, incident report comparison program 116 sends the list of incidents to the caller.

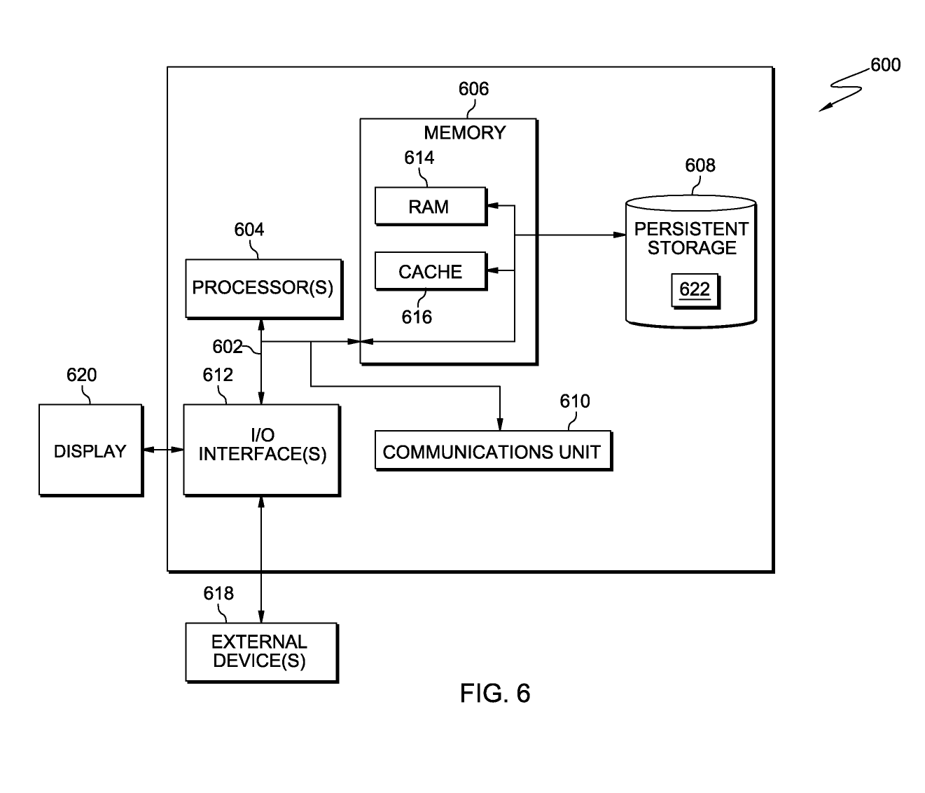

Client computer system 104 and server computer system 102 may each include internal and external hardware components, as depicted and described in further detail with respect to FIG. 6.

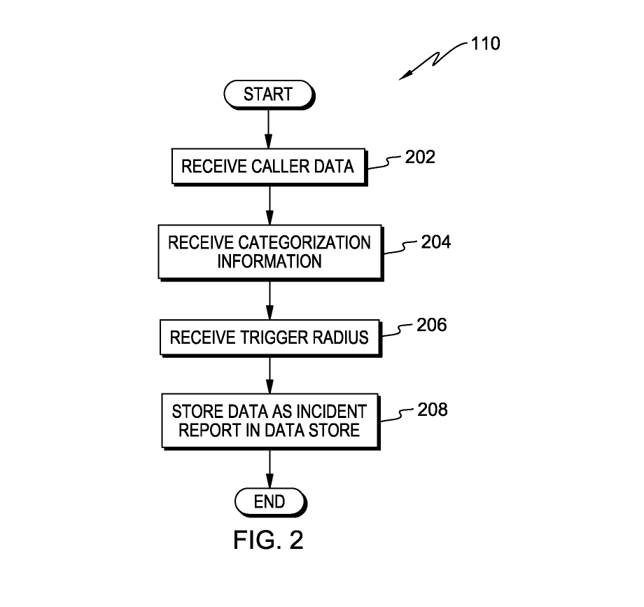

FIG. 2 is a flowchart depicting operational steps of incident report creation program 110 for creating and storing incident reports, in accordance with an embodiment of the present invention.

Incident report creation program 110 receives caller data (step 202). Caller data includes at least a location the call was made from. In one embodiment, the caller data also includes a caller name and number. In one embodiment, all or some of this information may be sent in digital form along with voice data of the original call. Incident report creation program 110 may parse out the caller data and place the data in an incident report. In an alternative embodiment, incident report creation program 110 receives this information from an operator taking the call.

Incident report creation program 110 also receives categorization information (step 204). In one embodiment, an operator taking the call categorizes the type of emergency (e.g., stalled vehicle, gunshot, robbery, hit and run, etc.) and incident report creation program 110 receives the categorization information directly from the operator input. Incident report creation program 110 associates the incident report being created with the categorization information. For example, incident report creation program 110 may store the incident report in a directory or database under a matching category. In another example, incident report creation program 110 may store the category within the incident report.

Incident report creation program 110 receives a trigger radius (step 206) that reflects the area in which the incident can be experienced by citizens (e.g., seen, heard, felt, etc.). For example, the typical gunshot may be heard for approximately a mile from the location at which it occurred, whereas a robbery may only be witnessed from citizens in close proximity, e.g., 50 yards, to the occurrence. An operator may enter a trigger radius or select a trigger radius from a drop-down list and incident creation program 110 may receive the trigger radius from the operator input. Alternatively, a trigger radius may be associated with the category of the incident reported and incident report creation program 110 may locate the relevant trigger radius from a mapping of incident categories and trigger radiuses.

Incident report creation program 110 stores the received data as an incident report (step 208) for example, in data store 112, such that incident report comparison program 116 may access the incident report in subsequent transactions. A person of ordinary skill in the art will recognize that, while in one embodiment, incident report creation program 110 locally creates and stores incident reports on server computer system 102, in an alternative embodiment, incident reports may be created on a separate system and sent to server computer system 102.

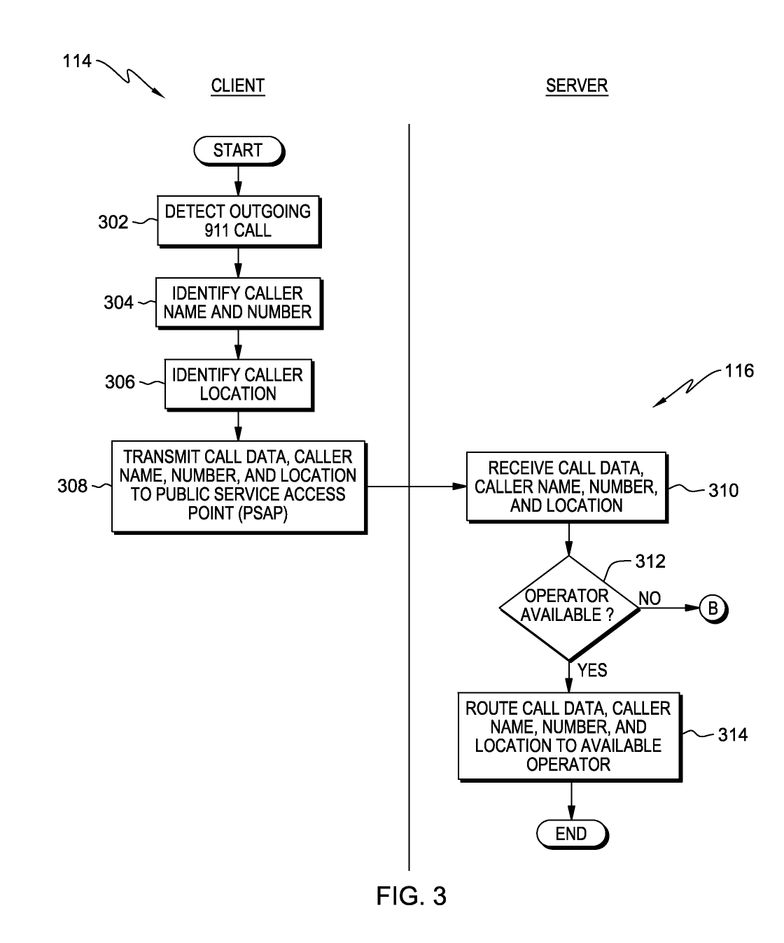

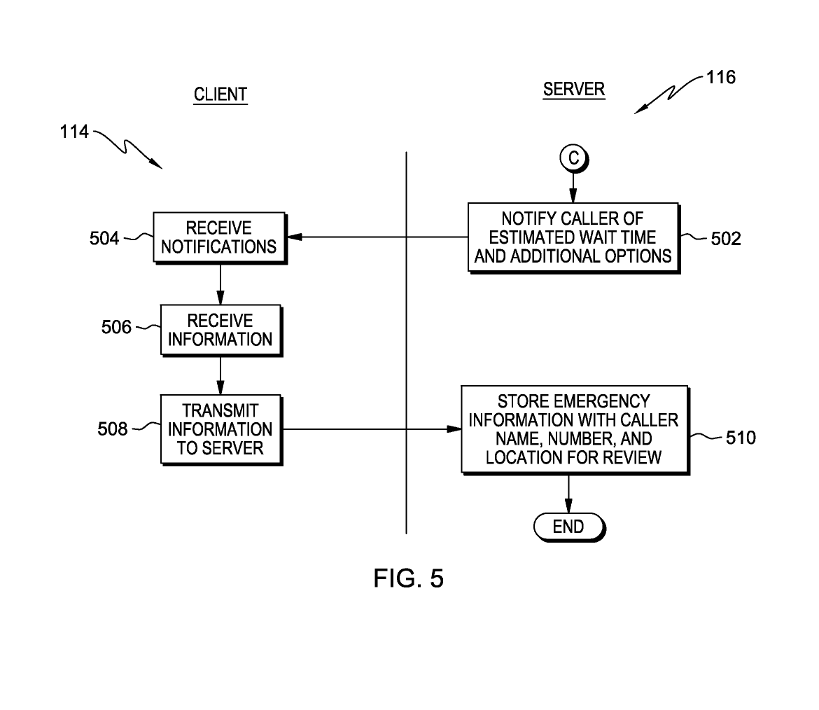

FIGS. 3, 4, and 5 depict the operational steps of emergency calling program 114 on client computer system 104 and incident report comparison program 116 on server computer system 102 as they would execute with respect to one another, in accordance with one embodiment of the present invention.

Emergency calling program 114 detects an outgoing emergency (e.g., 911) call (step 302). In one embodiment, when a user dials a number from client computer system 104, emergency calling program 114 briefly scans the number before allowing the call and determines whether the dialed number matches any predefined emergency numbers. For example, in the United States, the number combination 9-1-1 is designated for emergencies.

Emergency calling program 114 identifies the caller name and number (step 304), and identifies the caller location (step 306), for example using trilateration. Emergency calling program 114 transmits the caller data, including name, number, and location, to a PSAP (step 308). A person of ordinary skill in the art will recognize that such a transmission may be routed to a carrier's mobile switching center where the call can be sent to a dedicated 911 switch for routing to a PSAP, or can be routed directly to a PSAP, depending on the local emergency system's implementation. In an alternate embodiment, client computer system 104 may call out normally, and the carrier's mobile switching center may detect the emergency call, identify the caller and location, and forward the information to the PSAP.

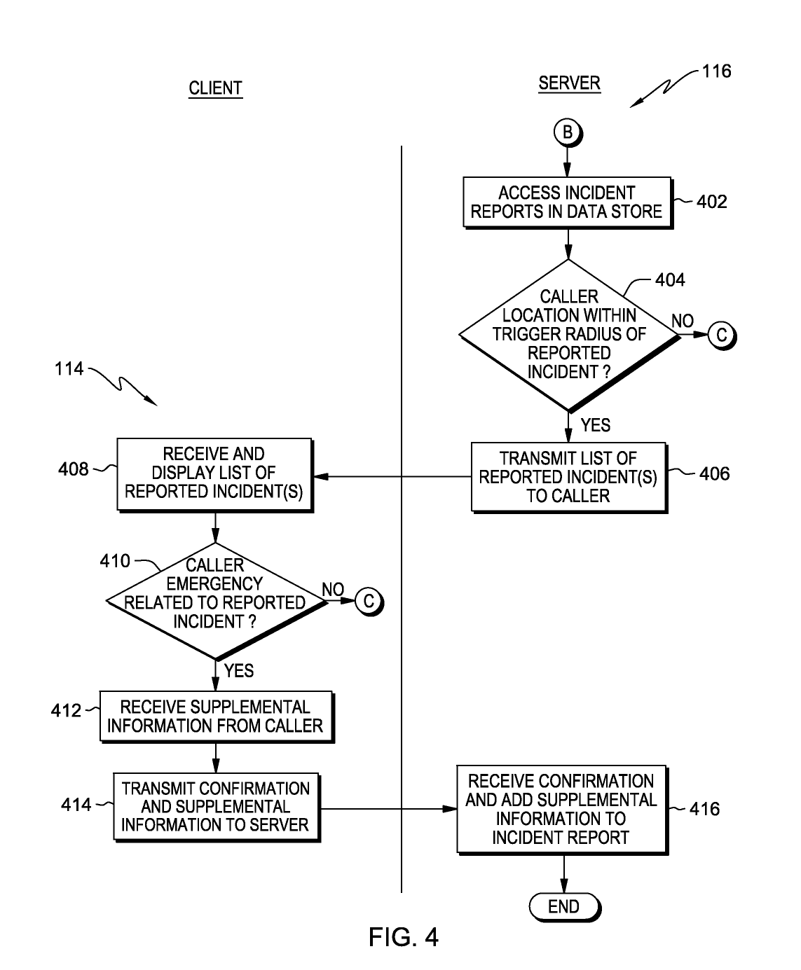

After the call and the associated caller data is transmitted, incident report comparison program 116, on server computer system 102, may receive the call and associated data (step 310). As previously discussed, server computer system 102 may be an intermediate computer or switch that determines where and if an emergency phone call should be forwarded to a PSAP, or a computer system maintained by a local PSAP that determines whether to forward an emergency phone call to an operator of the local PSAP. In one embodiment, incident report comparison program 116 determines whether an operator is available to take the call (decision 312). If an operator is available (yes branch, decision 312), incident report comparison program 116 routes the call and the associated caller data to the available operator (step 314). Server computer system 102, in conjunction with the operator, may create an incident report for the call, for example, as described in the exemplary implementation of incident report creation program 110 depicted in FIG. 2. If an operator is not available (no branch, decision 312), incident report comparison program 116 accesses existing incident reports in data store 112 (step 402 of FIG. 4). Though embodiments of the invention are directed at decreasing duplicative reporting, some embodiments also recognize that if operators are currently available, subsequent processing of the call by server computer system 102 may be largely unnecessary. Thus, one embodiment may always allow emergency calls to be routed to an available operator. Other embodiments may be devoid of decision 312 and step 314 and may automatically access existing incident reports in step 402 subsequent to receiving an emergency call in step 310.

Subsequent to accessing the incident reports, incident report comparison program 116 determines whether the caller location is within a trigger radius of one or more of the reported incidents (decision 404) as this might indicate that the call is in reference to one of the one or more reported incidents within the trigger radius. If incident report comparison program 116 determines that the caller location is within a trigger radius of one or more reported incidents (yes branch, decision 404), incident report comparison program 116 transmits the list of incidents within the trigger radius to client computer system 104 (step 406).

Emergency calling program 114 on client computer system 104 receives the list of reported incidents within the trigger radius and displays the list to the user (step 408). Emergency calling program 114 determines whether the emergency call that the user placed is related to a previously reported incident (decision 410). For example, emergency calling program 114 may receive a selection of one of the displayed reported incidents from the user.

In one embodiment, if the emergency call is related to a previously reported incident (yes branch, decision 410), emergency calling program 114 may receive supplemental information from the caller (step 412). For example, the existing incident report may be incomplete or indicate an operator request for photos, injury count, fire hazards, etc. Emergency calling program 114 may display such a request to the user and receive any supplemental information from the user. Emergency calling program 114 transmits a confirmation that the emergency call was related to a previously reported incident and any supplemental information to server computer system 102 (step 414).

Incident report comparison program 116 on server computer system 102 receives the confirmation and adds any received supplemental information to the existing incident report (step 416).

If, however, incident report comparison program 116 determines that the caller location is not within a trigger radius of one or more reported incidents (no branch, decision 404), or alternatively if emergency calling program 114 determines that the emergency call is not related to a previously reported incident and notifies incident report comparison program 116 (no branch, decision 410), then incident report comparison program 116 notifies client computer system 104 of an estimated wait time and any additional options (step 502). Additional options may include options to have an operator call the user back or for the user to fill out their own incident report for the emergency, which may be subsequently provided to an operator.

Emergency calling program 114 on client computer system 104 receives the notifications (step 504). In one embodiment, the user may elect to fill out an incident report (or otherwise supply information concerning the emergency) and/or to be contacted subsequently by an operator. Emergency calling program 114 receives any relevant information from the user (step 506), and transmits the information to server computer system 102.

Incident report comparison program 116 on server computer system 102 may store any received emergency information along with a caller name, number, and location, for subsequent review by an operator (step 510).

FIG. 6 is a block diagram of components of a computing system 600, such as client computer system 104 and server computer system 102, in accordance with an illustrative embodiment of the present invention. It should be appreciated that FIG. 6 provides only an illustration of one implementation and does not imply any limitations with regard to the environments in which different embodiments may be implemented. Many modifications to the depicted environment may be made based on design and implementation requirements.

Computing system 600 is representative of any electronic device capable of executing machine-readable program instructions. Examples of computing systems, environments, and/or configurations that may be represented by computing system 600 include, but are not limited to, personal computer systems, server computer systems, thin clients, thick clients, laptop computer devices, tablet computer devices, cellular telephones, multiprocessor systems, microprocessor-based systems, network PCs, minicomputer systems, and distributed cloud computing environments that include any of the above systems or devices.

Computing system 600 includes communications fabric 602, which provides communications between computer processor(s) 604, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Memory 606 and persistent storage 608 are computer-readable storage media. In this embodiment, memory 606 includes random access memory (RAM) 614 and cache memory 616. In general, memory 606 can include any suitable volatile or non-volatile computer-readable storage media.

Software 622 represents one or more operating systems and additional software stored in persistent storage 608 for execution by one or more of the respective computer processors 604 via one or more memories of memory 606. Software 622 includes one or more operating systems and emergency calling program 104 in client computer system 104, and one or more operating systems, incident report creation program 110, and incident report comparison program 116 in server computer system 102. In this embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer-readable storage medium that is also part of persistent storage 608.

Communications unit 610, in these examples, provides for communications with other data processing systems or devices via network 108. In the embodiment illustrated in FIG. 6, communications unit 610 includes network adapters or interfaces such as a TCP/IP adapter cards, wireless Wi-Fi interface cards, or 3G or 4G wireless interface cards or other wired or wireless communication links. Communications unit 610 may provide communications through the use of either or both physical and wireless communications links. Software 622 can be stored on computer-readable storage media of a remote computing system and downloaded to computing device 600 from the external computing system via a network (for example, the Internet, a local area network or other wide area network) and communications unit 610. From communications unit 610, software 622 can then be loaded onto persistent storage 608.

I/O interface(s) 612 allows for input and output of data with other devices that may be connected to computing device 600. For example, I/O interface(s) 612 may provide a connection to external devices 618 such as a keyboard, keypad, a touch screen, and/or some other suitable input device. External devices 618 can also include portable computer-readable storage media such as, for example, thumb drives, portable optical or magnetic disks, and memory cards. Software 622 can be stored on such portable computer-readable storage media and can be loaded onto persistent storage 608 via I/O interface(s) 612. I/O interface(s) 612 may also connect to a display 620.

Display 620 provides a mechanism to display data to a user and may be, for example, a touch screen or computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for managing emergency calls, the method comprising:
receiving an emergency call from a computing device;
receiving a location of the computing device placing the emergency call;
determining, by one or more computer processors, that the location of the computing device is within a geographic area surrounding a location of a previously reported incident;
responsive to determining that no operator is available, sending a notification of the previously reported incident to the computing device;
receiving an indication from the computing device that the emergency call is related to the previously reported incident; and
responsive to receiving the indication that the emergency call is related to the previously reported incident, handling the emergency call as a duplicative report of a known emergency, including requesting additional information related to the previously reported incident from the computing device based, at least in part, on a request for the additional information included in an incident report of the previously reported incident.

2. The method of claim 1, wherein requesting additional information related to the previously reported incident from the computing device comprises:
receiving user input identifying the request for additional information; and
appending the request for additional information to the report of the previously reported incident.

3. The method of claim 2, further comprising:
receiving additional information related to the previously reported incident from the computing device; and
appending the additional information to a report of the previously reported incident.

4. The method of claim 1, further comprising:
wherein said handling the emergency call as a duplicative report of a known emergency comprises, requesting the computing device to provide an indication of whether an operator should return a call to the computing device.

5. The method of claim 1, further comprising:
prior to receiving the emergency call from the computing device, receiving a report of the previously reported incident; and
determining the geographic area surrounding the location of the previously reported incident, wherein the geographic area represents a range at which a third party could experience the previously reported incident.

6. The method of claim 1,
wherein said sending the notification of the previously reported incident to the computing device comprises, sending a list of previously reported incidents to the computing device; and
wherein said receiving the indication from the computing device that the emergency call is related to the previously reported incident comprises, receiving a selection of the previously reported incident from the list of previously reported incidents.

7. A computer program product for managing emergency calls, the computer program product comprising:
one or more computer readable storage media;
program instructions stored on the one or more computer readable storage media, which when executed by a processor, perform the method of:
receiving an emergency call from a first computing device;
receiving a location of the first computing device placing the emergency call;
determining that the location of the first computing device is within a geographic area surrounding a location of a previously reported incident;
responsive to determining that no operator is available, sending a notification of the previously reported incident to the first computing device;
receiving an indication from the first computing device that the emergency call is related to the previously reported incident; and
responsive to receiving the indication that the emergency call is related to the previously reported incident, handling the emergency call as a duplicative report of a known emergency, including requesting additional information related to the previously reported incident from the computing device based, at least in part, on a request for the additional information included in an incident report of the previously reported incident.

8. The computer program product of claim 7, wherein requesting additional information related to the previously reported incident from the first computing device comprises:
receiving user input identifying the request for additional information; and
appending the request for additional information to the report of the previously reported incident.

9. The computer program product of claim 8, further comprising program instructions, stored on the one or more computer readable storage media, which when executed by a processor, perform:
receiving additional information related to the previously reported incident from the first computing device; and
appending the additional information to a report of the previously reported incident.

10. The computer program product of claim 7, wherein said handling the emergency call as a duplicative report of a known emergency comprises, requesting the first computing device to provide an indication of whether an operator should return a call to the first computing device.

11. The computer program product of claim 7, further comprising program instructions, stored on the one or more computer readable storage media, which when executed by a processor, perform:
prior to receiving the emergency call from the first computing device, receiving a report of the previously reported incident; and
determining the geographic area surrounding the location of the previously reported incident, wherein the geographic area represents a range at which a third party could experience the previously reported incident.

12. The computer program product of claim 7,
wherein said sending the notification of the previously reported incident to the first computing device comprises, sending a list of previously reported incidents to the first computing device; and
wherein said receiving the indication from the first computing device that the emergency call is related to the previously reported incident comprises, receiving a selection of the previously reported incident from the list of previously reported incidents.

13. The computer program product of claim 7, wherein the program instructions stored on the one or more computer readable storage media were downloaded over a network from a remote computing system.

14. The computer program product of claim 7, wherein the program instructions stored on the one or more computer readable storage media are stored on at least one computer readable storage medium of a server computing system, and wherein the program instructions can be downloaded over a network by a remote computing system for storage on at least one computer readable storage medium of the remote computing system.

15. A computer system for managing emergency calls, the computer system comprising:
one or more computer processors;
one or more computer readable storage media;
program instructions stored on the one or more computer readable storage media, for execution by at least one of the one or more computer processors, which when executed, perform the method of:
receiving an emergency call from a first computing device;
receiving a location of the first computing device placing the emergency call;
determining that the location of the first computing device is within a geographic area surrounding a location of a previously reported incident;
responsive to determining that no operator is available, sending a notification of the previously reported incident to the first computing device;
receiving an indication from the first computing device that the emergency call is related to the previously reported incident; and
responsive to receiving the indication that the emergency call is related to the previously reported incident, handling the emergency call as a duplicative report of a known emergency, including requesting additional information related to the previously reported incident from the computing device based, at least in part, on a request for the additional information included in an incident report of the previously reported incident.

16. The computer system of claim 15, wherein requesting additional information related to the previously reported incident from the first computing device comprises:
receiving user input identifying the request for additional information; and
appending the request for additional information to the report of the previously reported incident.

17. The computer system of claim 16, further comprising program instructions stored on the one or more computer readable storage media, for execution by at least one of the one or more computer processors, which when executed, perform:
receiving additional information related to the previously reported incident from the first computing device; and
appending the additional information to a report of the previously reported incident.

18. The computer system of claim 15, wherein said handling the emergency call as a duplicative report of a known emergency comprises, requesting the first computing device to provide an indication of whether an operator should return a call to the first computing device.

19. The computer system of claim 15, further comprising program instructions stored on the one or more computer readable storage media, for execution by at least one of the one or more computer processors, which when executed, perform:
prior to receiving the emergency call from the first computing device, receiving a report of the previously reported incident; and
determining the geographic area surrounding the location of the previously reported incident, wherein the geographic area represents a range at which a third party could experience the previously reported incident.

20. The computer system of claim 15,
wherein said sending the notification of the previously reported incident to the first computing device comprises, sending a list of previously reported incidents to the first computing device; and
wherein said receiving the indication from the first computing device that the emergency call is related to the previously reported incident comprises, receiving a selection of the previously reported incident from the list of previously reported incidents.
